(19) United States
(12) Patent Application Publication
(10) Pub. No.: US 2016/0029114 A1
(43) Pub. Date: Jan. 28, 2016

(54) WIRELESS EARPHONE SET

(71) Applicant: YUNG-LIN CHEN, TAIPEI (TW)

(72) Inventor: YUNG-LIN CHEN, TAIPEI (TW)

(21) Appl. No.: 14/341,850

(22) Filed: Jul. 28, 2014

(51) Int. Cl. H04R 1/10; H04W 4/00

(52) U.S. Cl. CPC H04R 1/1041; H04W 4/008; H04R 2420/07

(57) ABSTRACT

The invention is about a real wireless earphone set including of two no-wire linking earphone assemblies. The earphone set communicates to an audio source with wireless protocol directly or through a wireless transmitter assembly plugged in the audio source. One of the earphone assemblies may be integrated with a microphone for two-way communicating. Users can check and set some parameters for each of the earphone assemblies by the control software of the earphone set installed and run in the compatible audio source. Since there is no audio wire between the two earphone assemblies, they can be wireless paired to the audio source separately, and the users can set for the right/left or mono channel of the earphone assemblies with the control software, the invention offers more convenience, safety and fluency for users that users can choice to use only one or two earphone assemblies depending on different situations.

### BACKGROUND OF THE INVENTION

At resent years, it is more popular for people who own personal mobile devices (for example: a CD player, a MP3 player, a mobile phone, a notebook, etc.). Many of such kind devices are with audio system for playing music and video, and furthermore some of them are with wireless protocol for users to pair these devices to use different wireless accessories. Since it is more convenience and private for people to listen to music or communicate to others, people are used to plug an earphone, a headphone, or a headset in their personal mobile devices or pair an earphone, a headphone, or a headset to their personal mobile devices with wireless protocol for listening to audio signals. Besides the devices mentioned above, there are more and more devices, such as a personal computer, a digital television, a set of home theater, etc., built in wireless protocol for users to compatible to use other wireless devices, such as a wireless keyboard, a wireless loudspeaker, a wireless headphone, etc. However, no matter any kinds of devices transmit audio signals to any kinds of earphones, headphones, or headsets with wire or wireless protocol, these earphones, headphones, or headsets are linked by the audio wire from one side to the other side.

With the development of technology, processors are made smaller and smaller. Many electronic-control products are miniature because of the smaller processors. Besides processors are smaller, the velocity of the processors dealing with tasks is faster and faster. The electronic usage of the processors is lower, too. Some products could not been built in a processor before but it is possible now because these new features of the processors. Products built in the processor make it possible for users to control by software installed and run in the products itself or other compatible devices through linking a transmitting line or wireless protocol. Users can do some settings and fine tuning for these products. This feature increases the convenience and fluency of these products for users.

Besides the development technology of processors, the development technology for many kinds of batteries improves also. Batteries are made for more capacity and the size is smaller. The smaller size of batteries and processors make it possible to be installed in smaller electronics products.

### BRIEF OF SUMMARY OF THE INVENTION

According to one aspect of the present invention is about an earphone set, 2 earphone assemblies, and a wireless transmitter assembly which may or may not be used depending on whether there is a compatible wireless audio source or not. The main feature of the earphone set is there is no audio wire linking between the two earphone assemblies. The feature offers more convenience, safety and fluency for users. In accordance with another aspect of the present invention, the two earphone assemblies receive the audio signals from the audio source with wireless protocol in the same time, and they are wirelessly paired to the audio source/ or the wireless transmitter assembly separately. In accordance with another aspect of the present invention, the control software for the earphone set is provided. Some parameters of the earphone set is set or checked by the control software. In one situation, the right/ left or mono channel of the earphone assemblies can be set separately through the control software installed and run in the compatible audio source. It is convenience and fluency for the user to choice to use one side or 2 sides together depending on the different needs.

According to another aspect of the present invention, the earphone set might be integrated with a microphone as a communication earphone. Thus it can be used for two-way communication through an audio source with communicating function, such as a mobile phone. Users can set some parameters about the microphone through the control software of the earphone set, too.

Using wireless protocol and the no-audio wire design of the earphone set offers the user to move easier and safer. Since there is no wire between the 2 sides of the earphone set and the two earphone assemblies communicate to the audio source with wireless protocol separately, it is convenience and fluency for the user to choice to use one side or 2 sides together depending on the different situations.

Other aspects, features, and advantages of the invention will become apparent to those skilled in the art from the following detail description, which, taken in conjunction with the annexed drawings, discloses exemplary embodiments of the invention.

### BRIEF OF DESCRIPTION OF THE DRAWINGS

Figures are illustrated examples for the present invention and are not construed as limiting the scope of the invention claimed.

FIG. 1 illustrates an embodiment for the main functions and components of the control center in each of the earphone assemblies of the earphone set.

FIG. 2 illustrates an embodiment for the wireless transmitter assembly.

FIG. 3 illustrates an embodiment of the earphone set communicating to an audio source plugged a wireless transmitter assembly with wireless protocol.

FIG. 4 illustrates an embodiment of the earphone set communicating to an audio source directly with wireless protocol.

FIG. 5 illustrates an embodiment of the earphone set with a microphone in one of the ear assemblies for two-way use and communicating to an audio source with communicating function with wireless protocol.

### DETAILED DESCRIPTION OF THE INVENTION

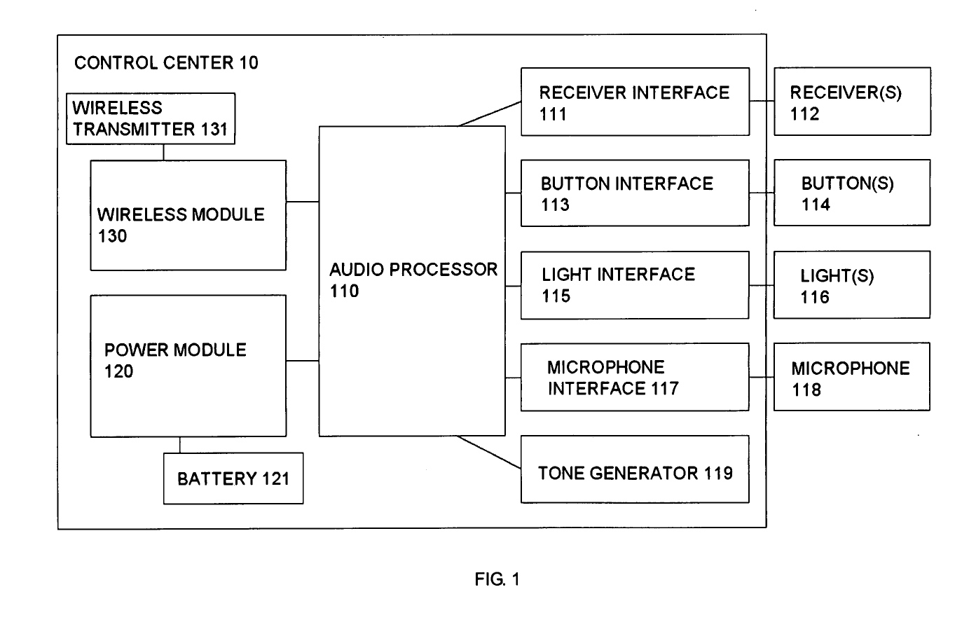

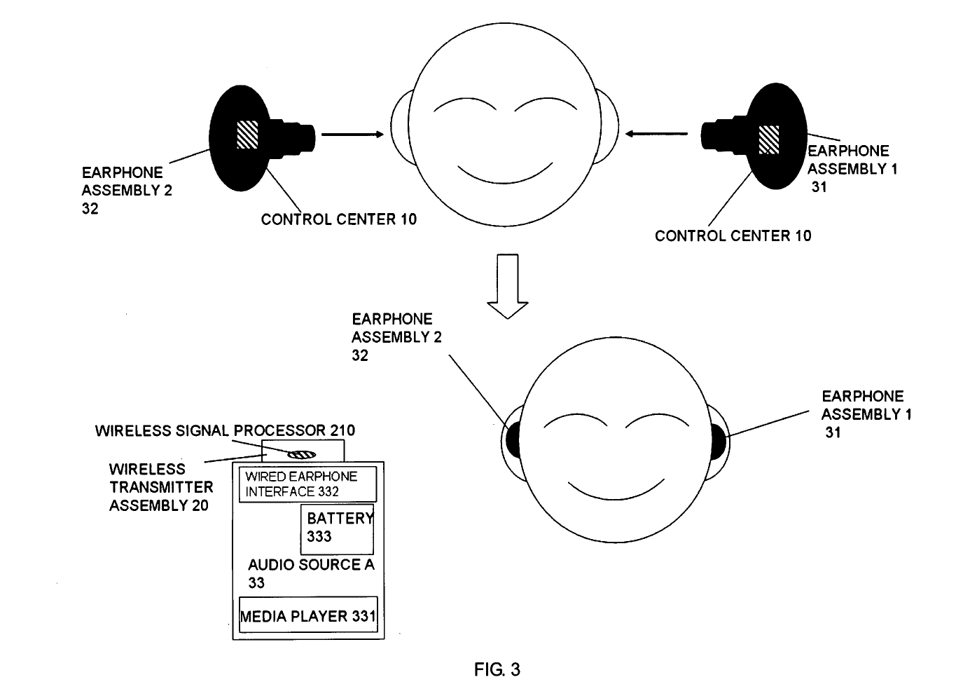

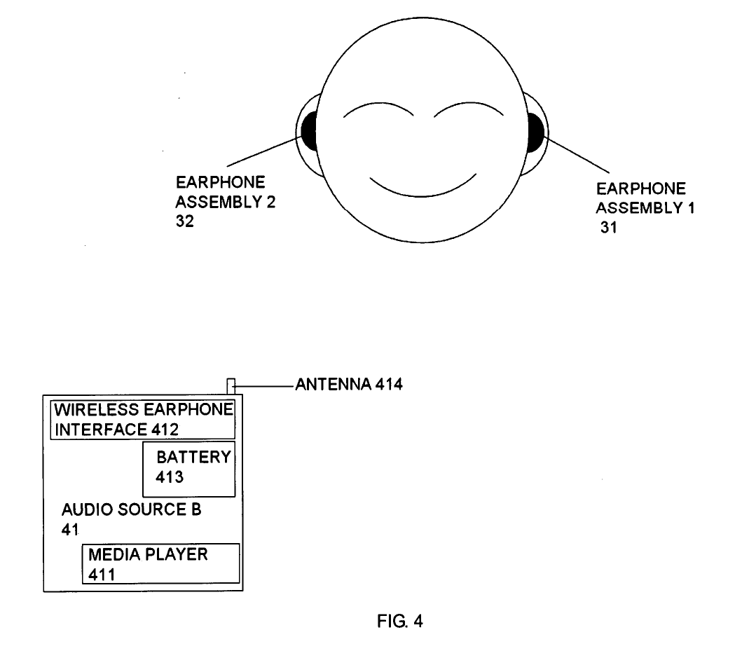

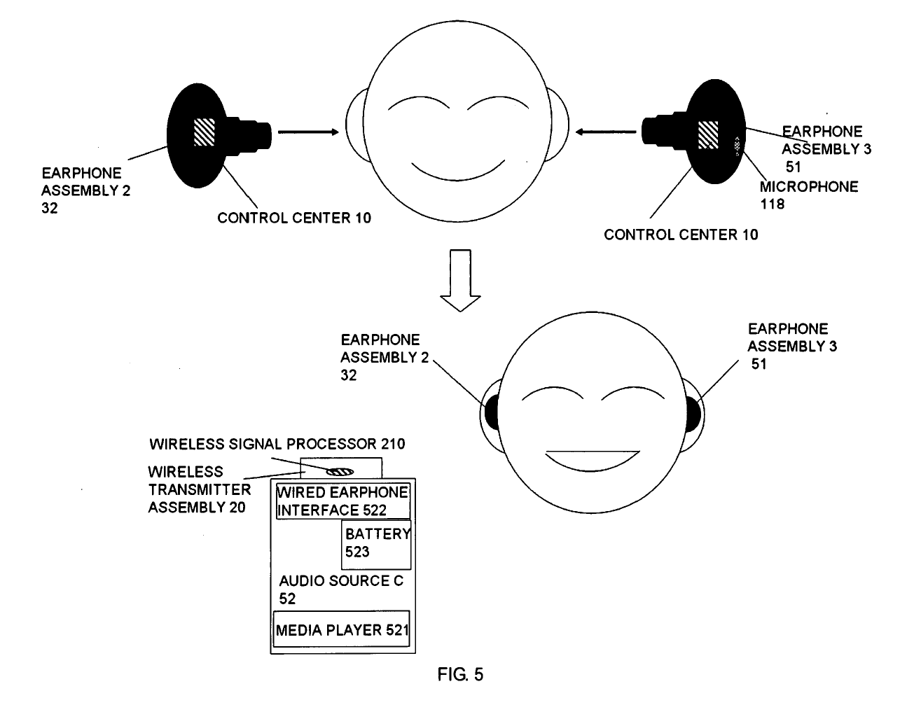

One aspect of this invention is about an earphone set including of an earphone assembly 1 31 and an earphone assembly 2 32 (FIG. 3 and FIG. 4) or an earphone assembly 3 51 and an earphone assembly 2 32 (FIG. 5). And another aspect of this invention is a wireless transmitter assembly 20. Each of the assemblies mentioned above is with a control center 10 (FIG. 1). The earphone assembly 1 31, the earphone assembly 2 32, or the earphone assembly 3 51, can pair to the wireless transmitter assembly 20 with wireless protocol separately, and they receive and send signals from and to the wireless transmitter 20 in the same time. The earphone assembly and the wireless transmitter assembly 20 transmit signals each other with wireless protocol, such as FM, Bluetooth or Wi-Fi and so on. User can depend on user's needs to use two of the earphone assemblies in the same time or one only. The wireless transmitter assembly 20 may or may not be used for transmitting audio signals, and the situation depends on whether an audio source with wireless protocol compatible to the earphone assemblies or not.

FIG. 1 illustrates an embodiment for the main functions and components of a control center 10. Each of the earphone assemblies, 31, 32, and 51, is installed one control center 10. There are three main parts of the control center 10: an audio processor 110, a power module 120, and a wireless module 130. The audio processor 110 is the most important component. The audio processor 110 links the power module 120 and the wireless module 130, and can be controlled by the control software of the earphone set installed in any compatible devices. Hence user can control the earphone set and do some setting of the earphone set by the control software installed in the compatible device.

The audio processor 110 is responsible for dealing with the right/left channel or the mono channel of the audio signals transmitting from the audio source. FIG. 3 will describe about the function.

The power module 120 of the control center 10 links a battery 121 and is the power source of the earphone assembly. The style of the battery 121 may be a rechargeable battery, a removable battery, a solar cell, or any other kinds of battery. The actual quantity of the battery 121 that the power module 120 links may be one to several depending on the need of the earphone assembly.

The wireless module 130 of the control center 10 links a wireless transmitter 131. When a wireless transmitter assembly 20 plugs to an audio source, the wireless module 130 pairs to the wireless transmitter assembly 20 with wireless protocol in order to send and receive audio signals to the wireless transmitter assembly 20 wirelessly. On the other hand, when the wireless module 130 pairs to an audio source with wireless protocol, the control center 10 can transmits signals to and receives signals from the audio source wirelessly.

The audio processor 110 links a button interface 113 and 1 to several buttons 114 for users to control the ear assembly directly, links a light interface 115 and 1 to several lights 116 for users to check the status of the earphone assembly easily, links a tone generation 119 for users to hear tone signals when operating the earphone assembly, and links to a receiver interface 111 and 1 to several receivers 112 in order to play audio sounds. The audio processor 110 may link a microphone. interface 117 and a microphone 118 for communicating use. FIG. 5 is an embodiment of the earphone set with a microphone in one of the ear assemblies that can be used for communication.

If the audio source is a computer, tablet, smart phone or any kinds of device that can be installed and run software, it may be installed the control software of the earphone set. Through wireless protocol, user can do and check some setting for the earphone assemblies of the earphone set. User can set or check one only or both sides together of earphone assemblies with the control software. The main components of the control software for the earphone set includes in a wireless pairing tool, a battery-management tool, and an audio tuning tool. The wireless pairing tool of the control software lets user to check whether the earphone assemblies already paired to the wireless transmitter assembly 20 or the device, the audio source, or not. If one or two of the earphone assemblies do not pair to the wireless transmitter assembly 20 or the device, user can set the wireless pairing tool to scan the earphone assemblies for wireless pairing. The battery-management tool of the control software let user check the battery usage of the earphone assemblies separately. The audio tuning tool of the control software lets user equalize the audio signals, do the fine tuning for the audio signals and store user's preference setting in the audio processor 110. So the user does not have to set preference again even using different audio source to play audio signals. If the control center 10 is installed the microphone interface 117 and a microphone 118, user can set some parameters about the microphone 118, such as sensitivity or beam width and so on, with the control software also.

The audio processor links a tone generator 119 in order to let the use hear tone sounds in some situation. It is convenience for users especially when users cannot check the situation of the earphone assemblies through the audio source. For instance if the ear assembly is in low-battery usage, the user hears the tone sounds for the low-battery alarm. Then the user is aware the earphone assembly will run out of its power. If the wireless pairing is unsuccessful or successful, the user hears different tone sounds to know the pairing situation.

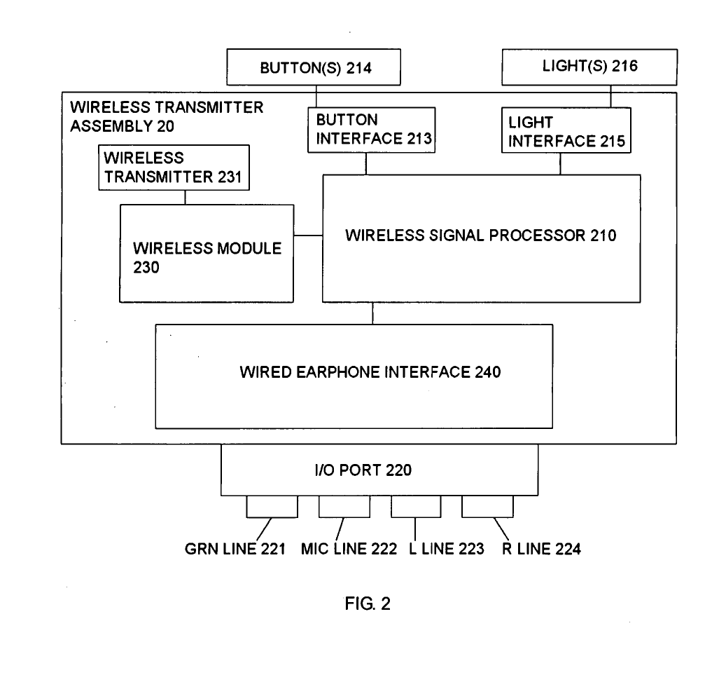

FIG. 2 illustrates an embodiment for the wireless transmitter assembly 20. The wireless transmitter assembly 20 has already in advance wireless paired to the two earphone assemblies of the earphone set separately in order to plug and use directly for users. Although the two earphone assemblies are wireless paired to the wireless transmitter assembly 20 separately, the two earphone assemblies can receive and send signals from and to the wireless transmitter assembly 20 with wireless protocol in the same time. And users can choice to use both or only one of the earphone assemblies depending on users' needs. Users may or may not use the wireless transmitter assembly 20 depending on whether an audio source for playing audio signals with wireless protocol compatible to the earphone assemblies or not.

The wireless signal processor 210 of the wireless transmitter assembly 20 is the main component and it links a wired earphone interface 240 and an I/O port 220 to connect to the audio source. The wireless signal processor 210 links a wireless module 230 and a wireless transmitter 231 and it pairs to the earphone assemblies in order to transmit signals with wireless protocol. If a user uses an audio source without wireless protocol compatible to the earphone assemblies, the user can plug the wireless transmitter assembly 20 to the headset jack of the audio source, and then the audio signals will transmit between the earphone assemblies and the audio source with wireless protocol through the wireless transmitter assembly 20. The power source of the wireless transmitter assembly 20 is the audio source. The wireless signal processor 210 links button interface 213 and 1 to several buttons 214 for users to operate the wireless transmitter assembly 20, for example users can ON/OFF or set to scan for wireless pairing through the button(s) 214. The wireless signal processor 210 links light interface 215 and 1 to several lights 216 for users to observe the status of the wireless transmitter assembly 20.

FIG. 3 illustrates an embodiment of the earphone set, an earphone assembly 1 31 and an earphone assembly 2 32, wirelessly communicates to an audio source A 33 by plugging a wireless transmitter assembly 20 in a headset jack of the audio source A 33. The wireless transmitter assembly 20 including of a wireless signal processor 210 has in advance paired to the earphone assembly 1 31 and an earphone assembly 2 32 with wireless protocol, such as FM, Bluetooth or Wi-Fi and so on, separately.

In the embodiment of FIG. 3, the audio source A 33, for example a personal computer, a tablet, a mobile phone, a personal digital assistant, a digital television, a MP3 player, a smart watch, an iPod, or a gaming device, comprises the function of media player, a wired earphone interface 332 which links a headset jack. The audio source A 33, lakes the compatible wireless protocol to pair to the earphone set, so the wireless transmitter assembly 20 is plugged in the headset jack of the audio source A 33 in order to transmit audio signals to the earphone set with wireless protocol. Each of the earphone assembly 1 31 and the earphone assembly 2 32 is with a control center 10 and a wireless module 130. The pair of the earphone assemblies, 31 and 32, has in advance paired to the wireless transmitter assembly 20 with wireless protocol. So when a user plugs the wireless transmitter assembly 20 to the headset jack of the audio source A 33 and play audio signals, the user can listen to the audio signal from the audio source A 33 to the 2 earphone assemblies, 31 and 32, through the wireless transmitter assembly 20 in the same time with wireless protocol.

Each of the earphone assemblies, 31 and 32 is with a control center 10 comprising a power module 120. The power module 120 is controlled by the audio processor 110 and including in a battery 121 for providing power to the earphone assemblies, 31 and 32. The power source of the wireless transmitter assembly 20 is from the audio source A 33. When a user wants to listen to the audio signals from the audio source A 33 with the earphone set, the user picks up the earphone assembly 1 31 and the earphone assembly 2 32, pushes the buttons of the earphone assembly 1 31 and the earphone assembly 2 32 for turning them on, then wears earphone assembly 1 31 and the earphone assembly 2 32 to the user's ears. Moreover the user pushes the button of the wireless transmitter assembly 20 for turning it on, then since the wireless transmitter assembly 20 has paired to the earphone assembly 1 31 and the earphone assembly 2 32 for wireless protocol in advance. The user will hear the tone sound for wireless pairing ready. Then the user runs the media player 331 of the audio source A 33. Now the user enjoys the audio signals with wireless protocol and the user can choice listening to audio signals with both or one of the earphone assemblies depending on the user's needs. If a user uses the two earphone assemblies, 31 and 32, in the same time, the audio processor of the earphone assembly 1 31 (the left earphone assembly) receives audio signals from the audio source A 33 through the wireless transmitter assembly 20, differentials the left or right channel of audio signals, and then sends the left channel audio signals only to the receiver of the earphone assembly 1 31; meanwhile, the audio processor in the earphone assembly 2 32 (the right earphone assembly) receives audio signals from the audio source A 33 through the wireless transmitter assembly 20 wirelessly, differentials the left or right channel of the audio signals, and then sends the right channel audio signals only to the receiver of the earphone assembly 2 32. Therefore the right channel of the audio signals transmits to the user's right ear, and the left channel of the audio signals transmits to the user's left ear.

For instance if the user uses only the earphone assemblies 1 31 (the left earphone assembly) and the user does not do the channel setting through the control software of the earphone set, the user listens to the audio signals for left channel only. If the user has done the channel setting from the right/left channel to the mono channel, the user listens to the audio signals for mono channel. In some situations what the user listen to for right/left channel or mono channel are different and the situations depend on the audio signals transmitting from the audio source.

If the audio source A 33 can be installed and run the control software for the earphone set, the user can check the wireless pairing status, the battery usage of the earphone assembly 1 31 and the earphone assembly 2 32, do some equalization tuning for playing audio signals, and do the right/left or mono channel setting with the control software. Furthermore, the user can store the preference setting of the equalization into the earphone assembly 1 31 and the earphone assembly 2 32, and the user does not have to re-set again for next use.

FIG. 4 is a little different from FIG. 3 that FIG. 4 illustrates an embodiment of the earphone set, including of an earphone assembly 1 31 and an earphone assembly 2 32, pairs to and communicates to an audio source B 41 directly with wireless protocol, such as FM, Bluetooth or Wi-Fi, and so on. In the embodiment of FIG. 4, the audio source B 41, for example a personal computer, a tablet, a mobile phone, a personal digital assistant, a digital television, a MP3 player, a smart watch, an iPod, or a gaming device, comprises the function of media player and a wireless protocol that can pair to the earphone set. Each of the earphone assembly 1 31 and the earphone assembly 2 32 is with a wireless module 130 and a wireless transmitter 131 and the pair of the earphone assemblies, 31 and 32, can pair to the audio source B 41, in the same time with wireless protocol. So the user can listen to audio signals from the audio source B 41 to the 2 earphone assemblies, 31 and 32, in the same time wirelessly.

When a user wants to listen to audio signals from the audio source B 41 with the earphone set, the user picks up the earphone assembly 1 31 and the earphone assembly 2 32 pushes the buttons of earphone assembly 1 31 and the earphone assembly 2 32 for opening them, then wears earphone assembly 1 31 and the earphone assembly 2 32 to the user's ears. Moreover if it is the first time for using the earphone set, the user has to scan and pair the earphone set and the audio source B 41 for wireless protocol. The user opens the antenna 414 of the audio source B 41 for wireless scanning status. And then the user push the buttons on the earphone assembly 1 31 and the earphone assembly 2 32 for setting them in the wireless pairing status. After the audio source B 41 wireless pairing to the earphone assembly 1 31 and the earphone assembly 2 32 successfully, the user hears the tone sounds generating from the control center 10 for the pairing successful. Then the user runs the media player 411 of the audio source B 41. The user now enjoys audio signals with wireless protocol and the user can choice listening to audio signals with two or only one of the earphone assembly 1 31 and the earphone assembly 2 32 depending on the user's needs.

If the audio source B 41 can be installed and run the control software of the earphone set, the user can check the wireless pairing status, the battery usage of the earphone assemblies, 31 and 32, do some equalization tuning for playing audio signals, and do the right/left or mono channel setting with the control software. Furthermore, the user can store the preference setting of the equalization into the earphone assembly 1 31 and the earphone assembly 2 32 separately, and the user does not have to re-set again for next use.

FIG. 5 illustrates an embodiment of the earphone set with a microphone 118 in the ear assembly 3 51 and the ear assembly 2 32 may or may not be installed a microphone. One of the ear assemblies with the microphone 118 can make the earphone set to be used as a 2-way communication earphone. The audio source C 52, such as a cell phone, a tablet installed the VoIP service . . . and etc, is with a media player 521 and the communication function. When the ear assembly 2 32 and the ear assembly 3 51 are wireless paired to the audio source C 52 with or without the wireless transmitter assembly 20, the earphone set can transfer user's voice to the audio source C 52 and receive the audio signals from the audio source C 52 through the wireless protocol. The audio source C 52 with or without the wireless transmitter assembly 20 depends on whether it comprising the wireless protocol which can pair and communicate to the earphone set or not.

When a user wants to use the earphone set as a communication earphone for the audio source C 52, the user picks up the earphone assembly 3 51 and the earphone assembly 2 32, pushes the buttons 114 of the earphone assemblies, 51 and 32, for opening them, then wears earphone assemblies, 51 and 32, to the user's both ears. Moreover the user plugs the wireless transmitter assembly 20 to a headset jack of the audio source C 52 and pushes the button 214 of the wireless transmitter assembly 20 for turning it on.

Since the wireless transmitter assembly 20 has pre-paired to the earphone assemblies, 51 and 32, with wireless protocol. The user hears the tone sounds for wireless pairing ready. Then the user runs the media player 521 of the audio source C 52 and now enjoys audio signals with wireless protocol.

If the user listens to the audio signals and the phone call coming, audio signals stop and the user hears tone signals for announcing the phone call coming bilaterally. The user can choice to pick the call up or hand it up directly with pushing the buttons 114 of the earphone assembly 3 51. When the call is pick up, the user uses the earphone assembly 3 51 as a wireless hand-free earphone. The microphone 118 of the earphone assembly 3 51 receives and transmits the user's voice to the audio source 52 through the control center 10 of the earphone assembly 3 51 wirelessly. And the user can hear the conversation sounds from both of the earphone assembly 3 51 and the earphone assembly 2 32. After the user ends the conversation, audio signals of the audio source C 52 come back to play automatically and then the user continues to listen to audio signals.

The user can choice listening to audio signals with both or one of the 2 earphone assemblies, 51 and 32, depending on the user's needs. In one situation, the audio source C 52 includes in the communication function and the user works. The user may use the earphone assembly 51 as a communication earphone only and not use the earphone assembly 32.

The user may or may not use the wireless transmitter assembly 20 depending on whether the audio source C 52 with wireless protocol compatible to the earphone assembly 3 51 and the earphone assembly 2 32 or not.

If the audio source C 52 can be installed and run the control software for the earphone set, the user can check the wireless pairing status, the battery usage of the earphone assemblies, 51 and 32, do some equalization tuning for playing audio signals, and do the right/left or mono channel setting with the control software. Furthermore, the user can store the preference setting of the equalization into the earphone assembly 3 51 and the earphone assembly 2 32 and the user does not have to re-set again for next use. The earphone assembly 3 51 with the microphone 118 for conversation use, and the user can set some parameters about the microphone 118 with the control software.

The appearance of the earphone assemblies, 31, 32, and 52, may be designed to be inserted into a user's ear canals, such as earbuds or in-the-ear ear-phones, or to be customized totally fit a user's ear canals, such as custom in ear monitors, or to be put outside closely to a user's ears with external hooks.

There are 1 to several buttons and 1 to several lights on the earphone assemblies, 31, 32, and 52, and wireless transmitter assembly 20. Users can turn on and off, control the volume of the audio signals, and control wireless pairing status with these buttons. Lights on these assemblies can help the user to understand the wireless pairing situation, signal transmission, low-battery alarm . . . and etc.

Embodiments of the present invention have been shown and described by reference to specific examples and in terms of particular allocations of functionality to certain hardware and/ or software components. However, it should be understood that the present invention embodies the inventive concepts as defined by the claims, and is not limited by any detailed description herein.

What is claimed is:

1. An apparatus containing:
one earphone set with two no-wire linked earphone assemblies which are connected to an audio source with wireless protocol;
each earphone assembly including in one control center.

2. the apparatus of claim 1, wherein the appearance of the earphone assembly is designed to be inserted into the user's ear canals, such as earbuds or in-the-ear ear-phones, or to be customized totally fit user's ear canals, such as custom in ear monitors, or to be put outside closely to user's ears with external hooks; whatever which appearance of the earpieces, there is no wire linked between the two earphone assemblies of the earphone set.

3. the apparatus of claim 1, wherein the control center contains three main sections: one audio processor, one battery system, and one wireless system.

4. the apparatus of claim 1, further containing:
one wireless transmitter assembly plugged in an audio source if the audio source lacks wireless protocol compatible to the earphone assemblies of the earphone set.

5. the apparatus of claim 3, further containing:
one microphone interface attached with the audio processor.

6. the apparatus of claim 5, wherein the audio processor attached to one microphone interface linking a microphone receives audio signals from an audio source directly or through the wireless transmitter assembly and send sound signals from the microphone of the earphone assembly to the audio source directly or through the wireless transmitter assembly, if the audio source, for instance a mobile phone, contains communication function.

7. the apparatus of claim 3, wherein the battery system containing:
one power module which links to and is controlled by the audio processor; and
one to several batteries, for instance a rechargeable battery, a removable battery, a solar cell, or any other kinds of battery.

8. the apparatus of claim 3, wherein the wireless system containing:
one wireless module which links to and is controlled by the audio processor; and
one wireless transmitter, for instance a transmitter of FM, Bluetooth, Wi-Fi or any kinds of wireless protocol.

9. a method of the earphone set in stereo containing:
each earphone assembly with one audio processor; wherein the audio processor of the right earphone assembly receives audio signals from an audio source directly or through the wireless transmitter assembly wirelessly, differentials left or right channel of the audio signals coming from the audio source, and then sends the right channel of the audio signals only to the receiver of the right earphone assembly; meanwhile, the audio processor of the left earphone assembly receives audio signals from the audio source directly or through the wireless transmitter assembly, differentials left or right channel of the audio signals, and then sends the left channel of the audio signals only to the receiver of the left earphone assembly.

10. the method of claim 9, further containing: a control software; wherein the control software can be installed and run in any compatible audio source, and users can control the control centers of the earphone assemblies by the control software when the audio source wirelessly pairs and links to the earphone assemblies.

11. the method of claim 10, wherein the control software containing:
a battery-management tool,
an audio tuning tool,
and a wireless pairing tool.

12. the method of claim 11, wherein the battery-management tool users can check the battery usage of each of the earphone assemblies through the audio source installed the control software.

13. the method of claim 11, wherein the audio tuning tool users can do the right/left or mono channel setting of the earphone assemblies, equalizer the audio signals, and store user's preference setting in the earphone assemblies.

14. the method of claim 11, wherein the wireless pairing tool user can check the wireless pairing status between the audio source and the earphone set.

15. the method of claim 10, wherein the control software further containing:
one microphone tool.

16. the method of claim 15, wherein the microphone tool user can set some microphone parameter of the earphone assembly with a microphone.
